(19) United States
(12) Patent Application Publication
(10) Pub. No.: US 2013/0107570 A1
(43) Pub. Date: May 2, 2013

(54) LED LAMP

(71) Applicants: CHIH-MING LIAO, TAOYUAN (TW); CHIH SUNG CHEN, NEW TAIPEI CITY (TW); CHI-FU CHUANG, NEW TAIPEI CITY (TW); JIH-SHENG HUANG, TAOYUAN COUNTY (TW)

(72) Inventors: CHIH-MING LIAO, TAOYUAN (TW); CHIH SUNG CHEN, NEW TAIPEI CITY (TW); CHI-FU CHUANG, NEW TAIPEI CITY (TW); JIH-SHENG HUANG, TAOYUAN COUNTY (TW)

(73) Assignee: ENLIGHT CORPORATION, TAOYUAN (TW)

(21) Appl. No.: 13/369,336

(22) Filed: Feb. 9, 2012

(30) Foreign Application Priority Data
Oct. 26, 2011 (TW) 100220123

(51) Int. Cl. F21V 7/00; F21V 8/00

(52) U.S. Cl. 362/609; 362/612

(57) ABSTRACT

The instant disclosure relates to an LED lamp, which includes a base, a lighting module, a light guiding assembly, and a retainer. A recess having a plurality of flat tabs arranged therein is formed on the base. The lighting module includes an annular member for disposing on the tabs and a plurality of lighting units. The annular member is constructed with a plurality of flat strips. The light guiding assembly is accommodated within the recess. The retainer has a plurality of engaging shafts protruding annularly toward the recess and abutting the respective end-to-end regions between adjacent strips. The lighting module is arranged between the engaging shafts and the tabs. The light guiding assembly is secured to the base by the retainer. Thus, the lamp can be assembled or dismantled by the user with more ease.

### BACKGROUND OF THE INVENTION

1. Field of the Invention

The instant disclosure relates to a lamp; in particular, to a lamp using a LED as the light source.

2. Description of Related Art

Conventionally, tungsten bulbs or mercury-vapor lamps are used as light sources for lighting applications. However, these light sources consume high energy and generate much waste heat. The emitted heat shortens the service life and increases the ambient temperature. Furthermore, the flickering problem of the fluorescent lamps is harmful to the eyes.

Therefore, new forms of light sources, such as a light-emitting diode (LED), are researched and developed to solve the aforementioned shortcomings Research shows the LEDs consume less energy with a lifespan far longer than the existing light sources. In addition, the absence of tungsten filaments or mercury with LEDs also poses no threat to the environment. Therefore, LEDs may very well replace conventional light sources in the coming future.

However, during the assembling process of the LED lamps, the cover plate screwed to the LED lamp has to be dismounted in order to change the components of the lamp. The dissembling procedures bring about inconvenience to the users and are also time-wasting.

To address the above issue, the inventors strive via industrial experience and academic research to present the instant disclosure, which can effectively improve the limitation described above.

### SUMMARY OF THE INVENTION

The object of the instant disclosure is to provide an LED lamp having a retaining member secured to a base, thus providing easy assembling and dismantling of the lamp components.

In order to achieve the aforementioned object, according to an embodiment of the instant disclosure, an LED lamp is provided. The LED lamp includes a base, a lighting module, a light guiding assembly, and a retaining member. The base has a recess concavely formed thereon, and a plurality of flat tabs is annularly arranged on the inner surface that defines the recess. The lighting module includes a plurality of lighting units and an annular member is arranged in correspondence with the tabs. The annular member is constructed by a plurality of strips. The light guiding assembly is received by the recess. The retaining member has a plurality of engaging shafts annularly arranged thereon, where the engaging shafts extend toward the base portion of the recess and abut the respective ends of the strips. The light guiding assembly is arranged between the engaging shafts and the tabs, where the retaining member abuts and secures the light guiding assembly on the base.

In conclusion, for the LED lamp of the instant disclosure, the recess of the base is defined by a polygonal annular sidewall. The shape of the lighting module corresponds to the shape of the annular sidewall and is arranged adjacently therewith. The engaging shafts of the retaining member engage to the lighting module. Thus, when the lamp is assembled, the retaining member allows the lighting module, the light guiding assembly, and other components to be movably secured to the base. Hence, the user can easily assemble or dismantle the lamp components.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a three-dimensional view of the LED lamp in accordance to the instant disclosure;

FIG. 2 shows a three-dimensional view of the LED lamp from another angle in accordance to the instant disclosure;

FIG. 3 shows a three-dimensional exploded view of the LED lamp in accordance to the instant disclosure;

FIG. 4 shows a three-dimensional exploded view of the LED lamp from another angle in accordance to the instant disclosure;

FIG. 4A is a partially magnified view of the portion A in FIG. 4;

FIG. 5 is a cross-sectional view of the A-A in the FIG. 2;

FIG. 6 is a cross-sectional view of the B-B in the FIG. 2.

### DETAILED DESCRIPTION OF THE PREFERRED EMBODIMENTS

Unless stated otherwise, all mentioned quantities are not intended to be limiting.

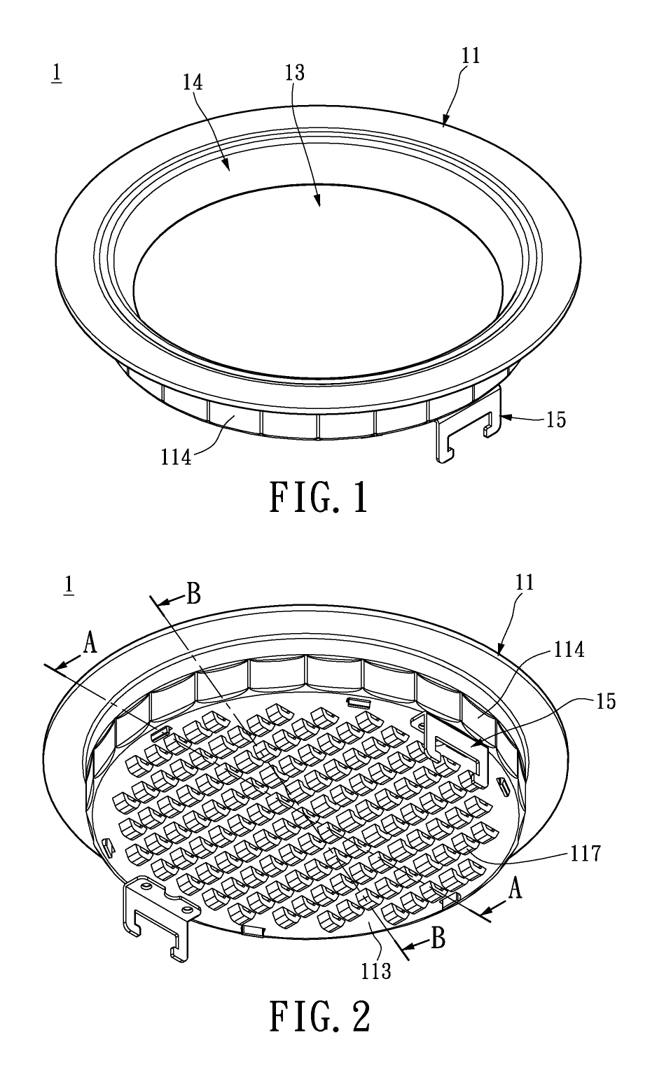

Please refer to FIGS. 1-4, which show a LED lamp 1 in accordance to an embodiment of the instant disclosure. This disclosed LED lamp 1 is particularly suitable for light fixtures that emit light laterally. The lamp 1 includes a base 11, a lighting module 12, a light guiding assembly 13, and a retainer 14.

The base 11 is preferably a bucket-like structure. However, the shape of the base 11 can also be rectangular or polygonal structure, where the structural design of the base 11 is not restricted. A recess 111 is concavely formed on the base 11. The recess 111 is defined by an inner sidewall having a plurality of flat tabs 112 arranged thereon. The tabs 112 are arranged end-to-end in forming an annular structure inside the recess 111.

The lighting module 12 includes an annular member 121 in correspondence with the tabs 112. The annular member 121 is formed by a plurality of flat strips 122. The shape of the annular member 121 is substantially the same as the shape of annular structure formed by the tabs 112. Each of the strips 122 is arranged in parallel to the corresponding tab 112, with the outer surface of the annular member 121 in contact with the tabs 112 of the base 11.

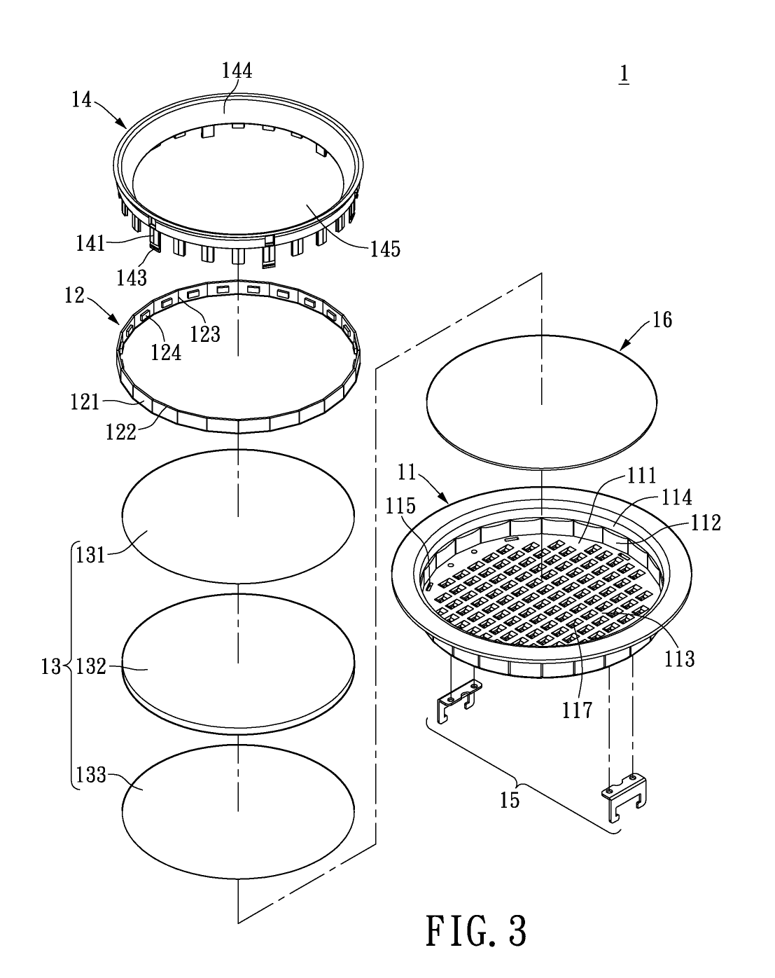

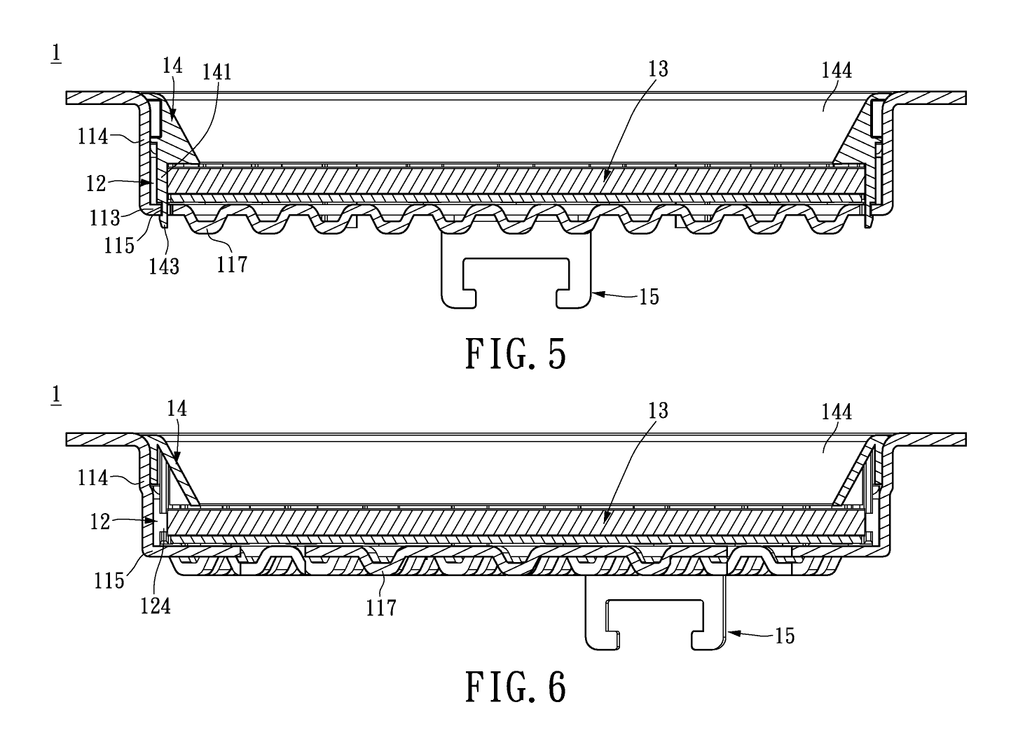

Please refer to FIGS. 3 and 5. The light guiding assembly 13 is accommodated by the recess 111. The lighting module 12 is arranged adjacently to the light guiding assembly 13, where the light source of the lighting module 12 emits light toward the light guiding assembly 13.

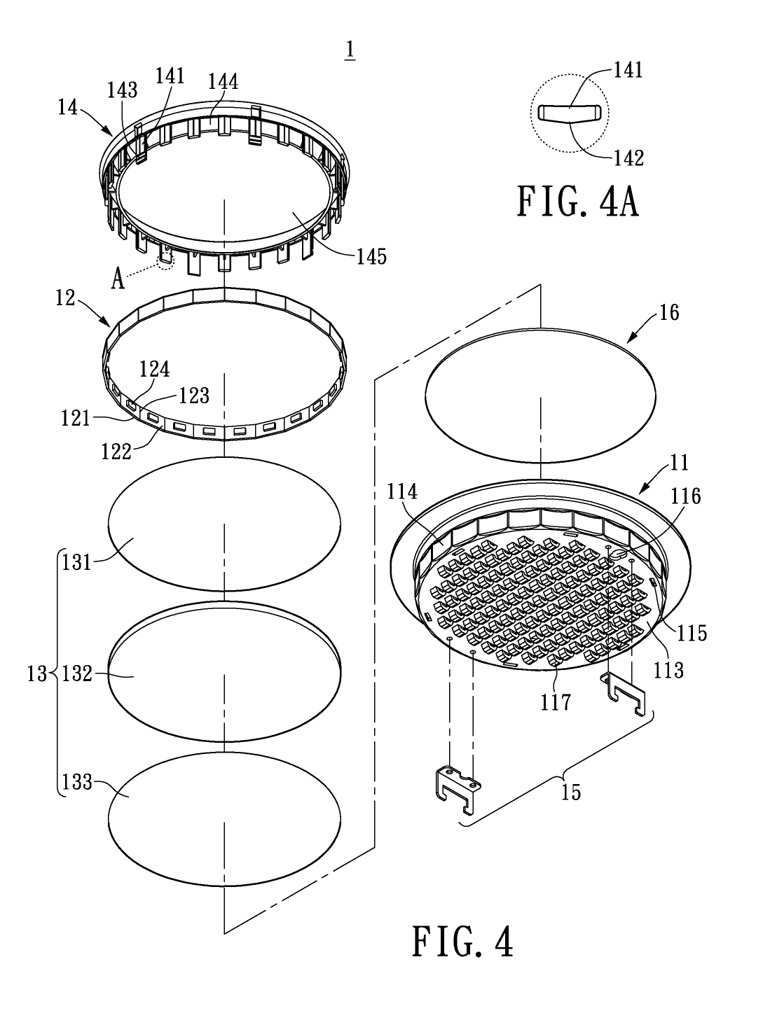

Please refer to FIGS. 3, 4 and 4A. The retainer 14 has a plurality of engaging shafts 141 protruding annularly arranged toward the lower generally planar surface of the recess 111. Each shaft 141 abuts to the respective edge portions of adjacent strips 122. As shown in FIG. 4A, each shaft has a protrusion 142. A plurality of abutting regions 123 are defined between adjacent strips 122. Each protrusion 142 abuts to the corresponding abutting region 123. The lighting module 12 is arranged between the engaging shafts 141 and the tabs 112. The retainer 14 retains the light guiding assembly 13 and is press-fit to the base 11. Thus, to dismantle the LED lamp 1, the user only needs to disengage the retainer 14 from the engaging structure of the base 11, to allow easier manipulation in changing the lamp components (e.g., lighting module 12). Such capability greatly increases the ease in using the lamp.

In the instant embodiment, the base 11 has a base surface 113 and an annular sidewall 114. The annular wall 114 protrudes upward from the periphery of the base surface 113 to define the recess 111. The flat tabs 112 are arranged around the annular sidewall 114 to form a polygonal structure. Preferably, the flat tabs 112 of the instant embodiment are arranged in forming an 18-sided polygon structure, but are not restricted thereto.

Please refer to FIGS. 3-4. At least one through hole 115 and at least one cable hole 116 are formed on the base surface 113 peripherally. At least one of the engaging shafts 141 has a restricting portion 143 arranged on its end, where the restricting portion 143 matches with the corresponding through hole 115 and is arranged proximate to the base surface 113 of the recess 111. The restricting portion 143 is inserted into the through hole 115 for securing purposes. Thus, the retainer 14 can be secured to the base 11 by selectively engaging the restricting portion 143 to the through hole 115.

The shaft 141 is an elastic member. The two long sides of each shaft 141 abut to the respective strips 122. Each shaft 141 also partially abuts the end-to-end region defined between adjacent strips 122. In other words, the area encircled by the engaging shafts 141 is substantially larger than the area encircled by the annular member 121. Thus, due to its elasticity, when the engaging shafts 141 are disposed in the recess 111, the engaging shafts 141 expand outward to exert pressure on the strips 122. Thereby, the lighting module 12 can be arranged securely on the base 11 by the engaging shafts 141 of the retainer 14.

The retainer 14 is an annular structure having a funnel-shaped ring portion 144 for securing the light guiding assembly 13. An opening 145 is defined centrally on the ring portion 144 corresponding to the light guiding assembly 13. The opening 145 communicates with the recess 111 and allows the light guiding assembly 13 to be partially exposed. The light emanating from the lighting module 12 is refracted or reflected by the light guiding assembly 13 and dispersed outward through the opening 145.

Please refer to FIGS. 3 and 5. The lighting module 12 includes a plurality of lighting units 124. The strips 122 are arranged in an end-to-end manner to form a polygon structure. Preferably, an 18-sided polygon structure is formed by the strips 122 for the instant embodiment, however they are not restricted thereto. The lighting units 124 are arranged on the inner surfaces of the strips 122 and equally spaced apart from one another. More specifically, each of the lighting units 124 is arranged between two adjacent engaging shafts 141. In other words, the lighting units 124 and the engaging shafts 141 are alternately arranged.

Please refer to FIGS. 3-4. The light guiding assembly 13 includes a diffuser 131, a light guiding plate 132, and a reflector 133 sequentially received in the recess 111. The diffuser 131 is abutted by the retainer 14, and the lighting units 124 touch the periphery of the light guiding plate 132. The light emitted from the lighting units 124 are directed to the light guiding plate 132 (shown in FIG. 6). Preferably, the light guiding plate 132 of the instant disclosure has micro diffusers. However, other light guiding plates may be used to provide different light guiding effects.

The base 11 has a plurality of wave-shaped heat-dissipating structures 117 formed on the base surface 113 to increase heat dissipation for the lamp 1.

Please refer to FIGS. 2 and 4. The instant embodiment further comprises at least two mounting brackets 15 arranged on the outer surface of the base 11. These brackets 15 can be fixed to the base 11 by using screws.

In addition, the instant embodiment further comprises a driver circuit (not shown) arranged on the outer surface of the base 11. The driver circuit is secured to the base 11 through the mounting brackets 15. The wires (not shown) of the lighting module 12 are electrically connected to the driver circuit via the cable hole 116.

Please refer to FIGS. 3 and 5. The instant embodiment further comprises a panel 16 made of a hard material. The panel 16 is preferably a non-transparent iron panel, but is not restricted thereto. The panel 16 is arranged between the base surface 113 and the light guiding assembly 13 to separate the reflector 133 from the base surface 113.

Please note, the directional terms mentioned in the instant disclosure such as: top, bottom, left, right, front, and back are only references for the attached figures. Therefore, the directional terms are merely for explanation purposes and are not intended to restrict the instant disclosure.

Based on the above, for the LED lamp of the instant disclosure, the recess of the base is defined by the polygonal sidewall. The lighting module is structurally compatible with the sidewall and abutted thereto. The retainer has multiple engaging shafts for holding the lighting module. Thus, when assembling the lamp, the lighting module, the light guiding assembly, and other components may be detachably attached to the base by the retainer. Thereby, the user can assemble or dismantle the LED lamp with more ease.

The descriptions illustrated supra set forth simply the preferred embodiment of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims

What is claimed is:

1. An LED lamp, comprising:
a base having a recess formed thereon, wherein a plurality of flat tabs are arranged on an inner sidewall defined for the recess;
a lighting module having a plurality of lighting units and an annular member, wherein the annular member is constructed by a plurality of flat strips and structurally compatible to the tabs;
a light guiding assembly accommodated by the recess; and
a retainer having a plurality of engaging shafts protruding annularly toward the base, wherein the engaging shafts abut to respective end-to-end regions defined between adjacent strips, wherein the lighting module is arranged between the engaging shafts and the tabs, with the light guiding assembly being retained by the retainer for securing to the base.

2. The LED lamp according to claim 1, wherein the base is defined by a base surface and the inner sidewall, wherein the inner sidewall protrudes annularly from the periphery of the base surface to define the recess, and wherein the tabs are annular arranged on the inner sidewall in forming a polygon structure.

3. The LED lamp according to claim 1, wherein at least one through hole and at least one cable hole are formed on the base surface peripherally, and wherein at least one of the engaging shafts has a restricting portion for engaging the corresponding through hole.

4. The LED lamp according to claim 1, wherein each engaging shaft is an elastic member and the two long sides of each engaging shaft abut to the adjacent strips, with each engaging shaft also partially abut to the corresponding end-to-end region between adjacent strips.

5. The LED lamp according to claim 1, wherein the retainer is an annular structure having a funnel-shaped ring portion, wherein an opening is defined centrally on the ring portion for exposing the light guiding assembly.

6. The LED lamp according to claim 1, wherein the strips are annularly arranged to form a polygon structure, wherein the lighting units are separately arranged on the respective inner surfaces of the strips, and wherein the lighting units and the engaging shafts are alternately arranged.

7. The LED lamp according to claim 1, wherein the strips are disposed in parallel on the respective tabs.

8. The LED lamp according to claim 1, wherein the light guiding assembly 13 includes a diffuser, a light guiding plate, and a reflector sequentially received by the recess, and wherein the diffuser is abutted by the retainer.

9. The LED lamp according to claim 1, wherein the base has a plurality of heat-dissipating structures formed thereon opposite of the base surface.

10. The LED lamp according to claim 1, further comprising a panel arranged between the light guiding assembly and the base surface.
